(19) United States
(12) Patent Application Publication
(10) Pub. No.: US 2026/0145875 A1
(43) Pub. Date: May 28, 2026

(54) FASTENING SYSTEM FOR A CONVEYOR BELT

(71) Applicant: Laitram, L.L.C., Harahan, LA (US)

(72) Inventors: Christopher Dale Russo, Covington, LA (US); Vincent R. Hamblin, New Orleans, LA (US)

(21) Appl. No.: 19/118,869

(22) PCT Filed: Oct. 17, 2023
(86) PCT No.: PCT/US2023/035264

§ 371 Date: Apr. 7, 2025

Related U.S. Application Data
(60) Provisional application No. 63/417,038, filed on Oct. 18, 2022.
(60) Provisional application No. 63/450,158, filed on Mar. 6, 2023.

(51) Int. Cl. B65G 15/30

(52) U.S. Cl. CPC B65G 15/30

(57) ABSTRACT

A fastening system for joining two ends of a conveyor belt segment includes hinge members having tapering noses for controlling movement of the ends relative to each other. A reinforcing link connects the tips of at least two outermost hinge members. A solid side edge encapsulates a hinge rod securing the two conveyor belt ends together, while a viewing window and lateral slot provide a pathway through the conveyor belt segment.

### BACKGROUND

The present invention relates generally to power-driven conveyor belts, and more particularly to a system and method for connecting ends of a conveyor belt body to form an endless conveyor belt.

Low tension, direct drive conveyor belts are typically used in situations where hygiene and cleanliness are important. For example, in food processing plants, such as those that process meat products for human consumption, low tension, direct drive conveyor belts are used to transport items. Sanitation is important and, therefore, the endless belts used in such conveyors are conventionally made of materials that can be hygienically cleaned, such as thermoplastics or stainless steel.

An example of a flexible endless belt suitable for implementing an illustrative embodiment of the invention is shown in FIG. 1. An endless conveyor belt 10 in a typical installation moves around two sprockets 12 and 14, drums or pulleys. A first sprocket 12 may be a drive sprocket for driving the conveyor belt, while the second sprocket may be an idle or slave sprocket 14. The belt 10 has an outer surface 110 serving as an article-conveying surface and an inner surface 22 serving as a drive surface. The inner surface 22 includes drive elements, illustrated as teeth 26, preferably spaced equidistantly from each other along the inner driven surface 22. The teeth 26 engage grooves or other drive features spaced around the circumference of the sprockets 12, 14 to move the belt. The upper span of the belt will travel in the direction of arrow 15. The flexible belt 10 wraps around the sprocket and may also be supported by a return roller, or shoe or drum, in the return path.

The belt is made of a resilient material, such as a thermoplastic polymer, an elastomer, or a rubber, and is flexible along its length.

A flexible toothed belt is normally formed by joining two ends of the belts together at a seam 102. Methods of joining two ends of the belts together include splicing, whereby splicing presses are used to weld the butt ends of the conveyor belt sections together, mechanical means, such as a hinge-pin system and/or a knuckled connector system described in U.S. Pat. Nos. 8,002,110 and 8,695,790, the contents of which are incorporated herein by reference.

The belt may have to be removed from the sprockets for maintenance of the system, for cleaning, or for repair. Removing the endless belt 10 of FIG. 1 poses an inconvenience, normally requiring disassembly of the conveyor frame, movement of the sprockets, and possibly destruction of the belt (or at least cutting the belt to be re-seamed later).

A drawback of certain mechanical means for joining together conveyor belt ends includes a hinging or “tenting” effect in the area of the seam when the belt moves around a sprocket, whereby the ends of the conveyor belt project away from the sprocket, migration of connecting rods, catchpoints and other drawbacks. In addition, stresses on the material during operation cause wear and can interfere with operation.

### SUMMARY

The present invention provides a fastening system for a conveyor belt. The fastening system comprises belt segments joined by interleaving hinge members having tapering noses for controlling movement of two belt segment ends relative to each other. A reinforcing link connects the tips of at least two hinge members and solid edges encapsulate a hinge rod within the fastening system. A viewing window and lateral slot provide a pathway through the conveyor belt segment at the solid edges.

According to one aspect, a fastening system for fastening a first end of a conveyor belt segment to a second end of a conveyor belt segment comprises at least one flexible belt segment, a plurality of hinge members and a reinforcing link. Each flexible belt segment extends in a longitudinal direction from a first end to a second end, in a lateral direction from a first side edge to a second side edge and in thickness from an outer surface to an inner surface. The hinge member are laterally spaced and extend from the first end of the flexible belt segment. The hinge members have aligned hinge openings forming a hinge passageway extending along a hinge axis. The reinforcing link extends between a tip of a first hinge member and a tip of a second hinge member adjacent the first hinge member.

According to another aspect, a fastening system for fastening a first end of a conveyor belt segment to a second end of a conveyor belt segment comprises first and second belt segments, laterally-spaced hinge members and a viewing window in a solid side edge. Each belt segment extends in a longitudinal direction from a first end to a second end and has an outer surface and an inner surface. The laterally-spaced hinge members extend from each first end and have aligned hinge openings forming a hinge passageway. The hinge passageway terminates in a solid edge at a first side of the belt segment to encapsulate a hinge rod inserted in the hinge passageway. The viewing window is adjacent the solid edge and extends from the outer surface to a lateral slot in the inner surface. The lateral slot aligns with the hinge openings.

According to another aspect, a fastening system for fastening a first end of a conveyor belt segment to a second end of a conveyor belt segment comprises a hinge body extending longitudinally from a first end of a conveyor belt segment and a tapering nose extending from the hinge body. The hinge body has a hinge opening extending along a hinge axis, and the conveyor belt segment has an outer surface and an inner surface. The tapering nose has a top angled interface surface that angles downwards from above the hinge axis and terminating in a tip below the hinge axis.

### BRIEF DESCRIPTION OF THE DRAWINGS

These features of the invention, as well as its advantages, are better understood by referring the following description, appended claims, and accompanying drawings, in which:

FIG. 1 illustrates an endless conveyor belt of the prior art;

FIG. 2 is an isometric view of a top of an assembled fastening system for a conveyor belt embodying features of the invention;

FIG. 3 is an isometric view of a bottom of the assembled fastening system of FIG. 2;

FIG. 4 is a top view of the assembled fastening system of FIG. 2;

FIG. 5 is an isometric top view of a belt segment of the fastening system of FIG. 2;

FIG. 6 is a top view of the belt segment of FIG. 5;

FIG. 7 is a bottom view of the belt segment of FIG. 5;

FIG. 8 is a detailed view of a top of a first side of the belt segment of FIG. 5;

FIG. 9 is a detailed view of a bottom of a first side of the belt segment of FIG. 5;

FIG. 10 is another detailed view of the bottom of the first side of the belt segment of FIG. 5;

FIG. 11 is a detailed view of the bottom of the fastening system of FIG. 2 near a side edge;

FIG. 12 is a detailed cross-sectional view of the fastening system of FIG. 2;

FIG. 13 is a detailed view of a bottom of a second side of the belt segment of FIG. 5;

FIG. 14 is an isometric bottom view of the second side of the belt segment of FIG. 5;

FIG. 15 is a side view of a hinge element of a fastening system according to an embodiment;

FIG. 16 is a cross sectional view of a fastening system in an operating position according to an embodiment.

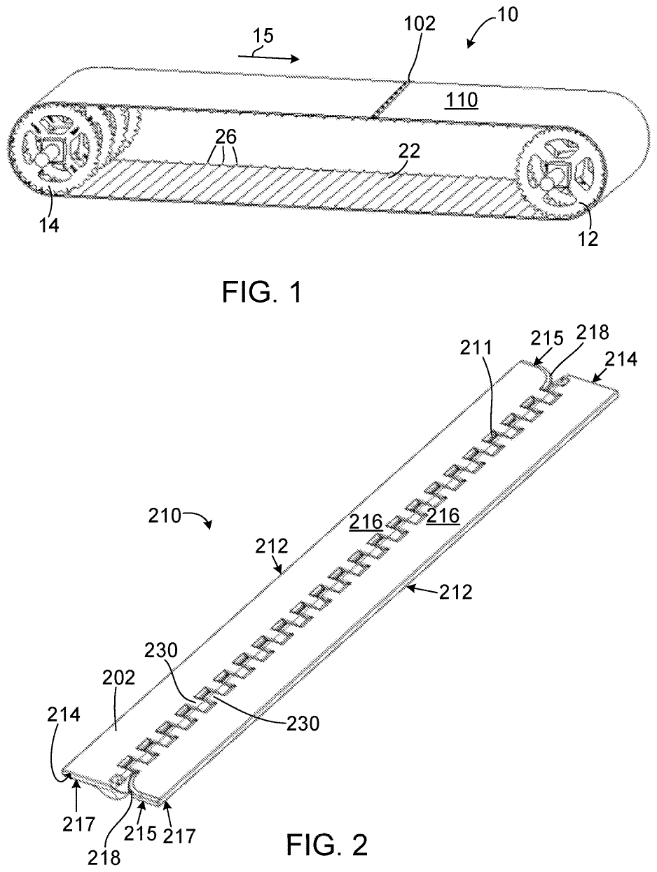

### DETAILED DESCRIPTION

The present invention provides a fastening system for facilitating assembly and disassembly of a conveyor belt. The present invention will be described below relative to an illustrative embodiment. Those skilled in the art will appreciate that the present invention may be implemented in a number of different applications and embodiments and is not specifically limited in its application to the particular embodiments depicted herein.

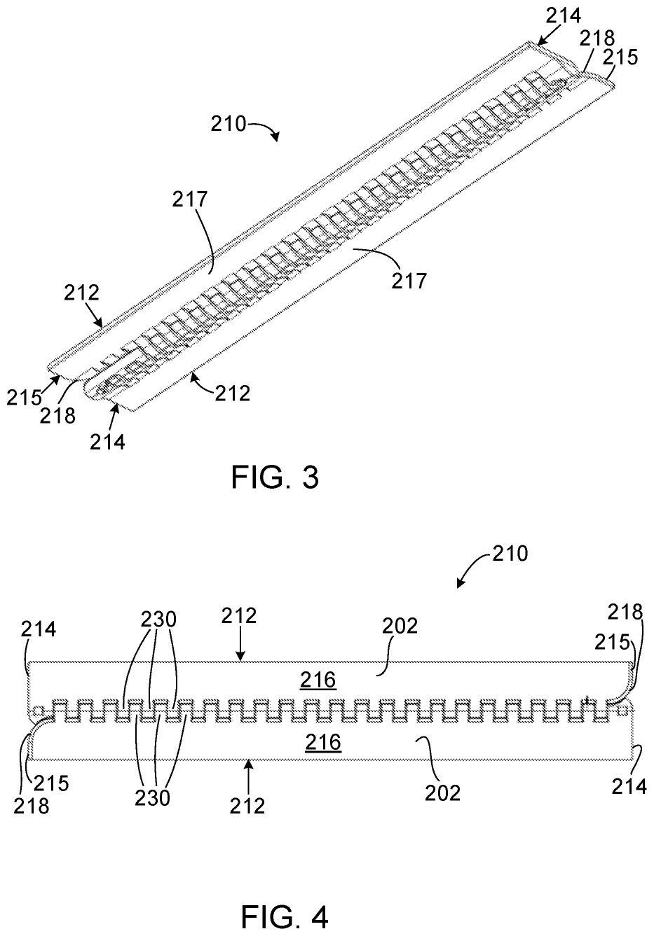

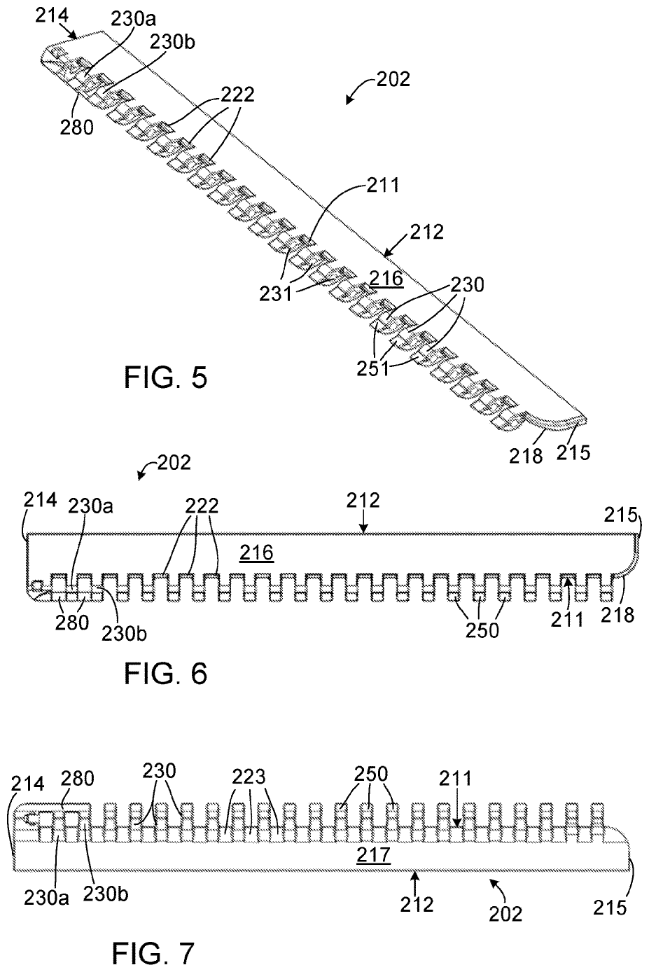

FIGS. 2-4 illustrate a fastening system 210 for a conveyor belt according to an illustrative embodiment of the invention. The fastening system 210 comprises two identical or substantially identical belt segments 202, 202 joined together at a seam to form a complete conveyor belt or an extended conveyor belt segment. Each belt segment 202, 202, shown alone in FIGS. 5-7, comprises a belt body that extends longitudinally from an inner, mating end 211 to an outer end 212 and laterally from a first side 214 to a second side 215. A curved edge 218 connects the second side 215 to the inner end 211. The body of each belt segment 202, 202 extends in thickness from an outer surface 216, illustrated as a conveying surface for conveying a product, to an inner surface 217, which can be a drive surface. The segments join together at the inner ends 211 to connect the segments together.

A conveyor belt of the illustrative embodiment may comprise a plurality of belt segments sequentially joined together, or a single belt segment having ends joined together using the fastening system 210 to form an endless belt.

The conveyor belt segment can be formed of any suitable material, such as a thermoplastic polymer, an elastomer, or a rubber, and is preferably flexible along its length about a lateral axis. The conveyor belt segment can be made from any of a number of methods, e.g., milling, extrusion, and/or injection molding.

In one embodiment, the fastening system 210 is formed separately from the main body of the conveyor belt and then joined to the main body to integrate the fastening system with the conveyor belt. For example, the outer ends 212 can be welded, spliced or otherwise joined to ends of the conveyor belt to integrate the fastening system with the conveyor belt. In one embodiment, the fastening system 210 is formed of a different material from the main body of the conveyor belt. For example, the fastening system 210 may be formed of a rigid plastic or other suitable material, then bonded to the flexible material forming the main body of the conveyor belt. In another embodiment, portions of the fastening system 210, such as hinge elements, can be formed of rigid plastic or another rigid material, then overmolded with a flexible plastic or otherwise attached to other portions of the conveyor belt or conveyor belt segment. The rigid plastic material increases the durability and strength of the conveyor belt in the fastening region, while the belt can still bend about the mating ends 211 to allow the conveyor belt to move around sprockets and rollers.

The illustrative conveyor belt fastening system 210 includes a plurality of laterally-spaced apart hinge members 230 extending longitudinally from the inner end 211 of a belt segment 202. The hinge members 230 are arranged to interleave with one or more laterally-spaced hinge members on the opposing belt segment inner end 211. Aligned openings 231 in the interleaved hinge members 230 form a lateral passageway when the ends are interleaved. A hinge rod is inserted into the lateral passageway to connect the inner ends of the belt segments 202, 202 at the seam, forming an endless belt or an extended belt segment. The ends of the hinge passageway are closed at the first side 214 to encapsulate the ends of the hinge rod when inserted between two interleaved belt segments 202, 202, preventing escape of the hinge rod during operation.

The first side 214 and second side 215 are shaped and complementary to each other, so that two identical segments opposing each other fit together at each side, with the hinge members 230 interleaved therebetween.

In one embodiment, the hinge members 230 may be formed on a separate or intermediate belt segment adapted to be spliced or otherwise connected to an end of a conveyor belt segment. Alternatively, the hinge members 230 may be formed directly on an end of a conveyor belt segment.

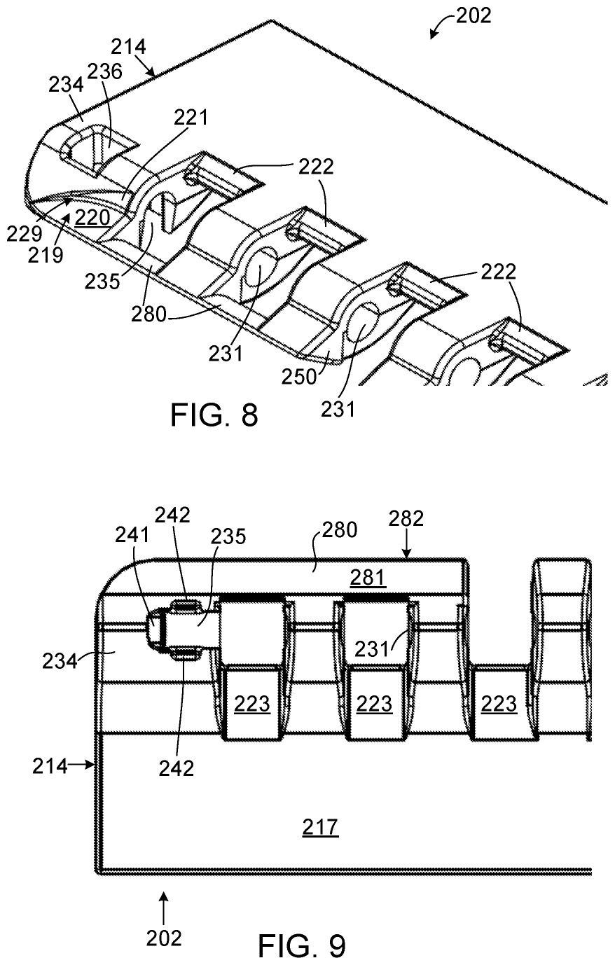

The inner edge 211 of the belt segment 202 may be shaped to facilitate the connection between two segments 202. For example, in the illustrative embodiment, the belt segment includes recesses 222 in the top surface between the hinge members 230 and longer recesses 223 in the inner surface between the hinge members 230. The illustrative recesses 222, 223 are formed by beveling or chamfering the outer surface 216 and inner surface 217 towards the inner end 211 of the belt body, as shown in FIGS. 8 and 9. The recesses 222, 223 prevent or reduce protrusion of the belt outer surface as the belt flexes around a sprocket or other device in a conveyor system.

The illustrative hinge members 230 each includes a tapering nose 250 extending longitudinally inwards, as described below. The tapering nose is configured to engage a bottom recess 223 in an opposite conveyor belt segment end to facilitate the connection and bending between the two belt ends, as described below.

The fastening system 210 further includes a reinforcing link 280 extending between the tips of the two outermost hinge members 230a, 230b and the first side 214 of the conveyor belt segment 202, where the end of the hinge rod is encapsulated within the conveyor belt segment 202. The reinforcing link 280 reinforces the end hinge members to prevent or reduce deformation from axial forces imparted by the rod. The illustrative reinforcing link 280 ties the two outermost hinge members 230a, 230b and the first side 214 together.

As shown in FIGS. 8-12, the reinforcing link 280 has a bottom surface 281 that aligns and coincides with the bottom surfaces of the hinge members 230a, 230b at the tapering nose 250. A tip 282 aligns with the tip of the tapering noses 250. A top surface 283 of the reinforcing link between the hinge members 230a, 230b and between the first side 214 and hinge member 230b slopes downwards to recede from the tip of the tapering nose, so that the top surface 283 is below the tapering noses of the hinge members. The illustrative top surface is 283 is convexly curved.

The first side 214 of the belt segment 202 is configured to facilitate insertion, retention and removal of the hinge rod used to fasten the two belt ends together. As shown in FIGS. 8-10, the first side 214 includes a solid edge portion 234. The solid edge portion 234 aligns with a hinge passageway formed by aligned openings 231 and an aligned lateral slot 235 in the first side region. The slot 235 opens to the inner surface 217 of the belt segment 202 and is closed to the top surface 216. The solid edge portion 234 encapsulates the hinge rod within the side of the conveyor belt to prevent escape of the hinge rod while the conveyor belt is running.

A viewing window 236 adjacent the solid edge portion 234 extends from the outer surface 216 and intersects the lateral slot 235 forming a portion of the hinge passageway. The viewing window 236 servers as both a positive visual indication to the user that the hinge rod is fully inserted and acts as a clear pathway to easily flush out product buildup. The viewing window 236 has a solid bottom to cradle the end of the hinge rod, while the lateral slot 235 is open towards the bottom surface 217 to allow insertion and removal of the hinge rod when required.

The belt segment 202 has a shaped shelf 219 in the top surface between the first side 214 and the reinforcing link 280 for accommodating the curved edge 218 in a mating belt segment, as shown in FIGS. 2 and 4. As shown in FIG. 8, the shaped shelf 219 includes a flat wall 220 recessed from the top of the solid edge portion 234. The flat wall 220 may extend at the same angle as the top of the tapering noses of the hinge members. The shaped shelf 219 has a curved inner edge 229 complementary to and forming a seat for the curved edge 218 of a mating segment. A curved, tapering wall 221 intersects the curved inner edge of the flat wall 220. The curved, tapering wall 221 extends from the slot 235 to a front edge for seating and containing a front wall of the curved edge 218 of a mating belt segment. The interface between the curved edge 218 and shaped shelf 219 provides a strong connection, facilitates assembly and reduces catchpoints during operation of the conveyor belt. The belt segment may taper in thickness at the curved edge 218 (i.e., include a bottom chamfer or recess in line with the recess 223 between the hinge elements) to enhance the interface between two belt segments at the side edges.

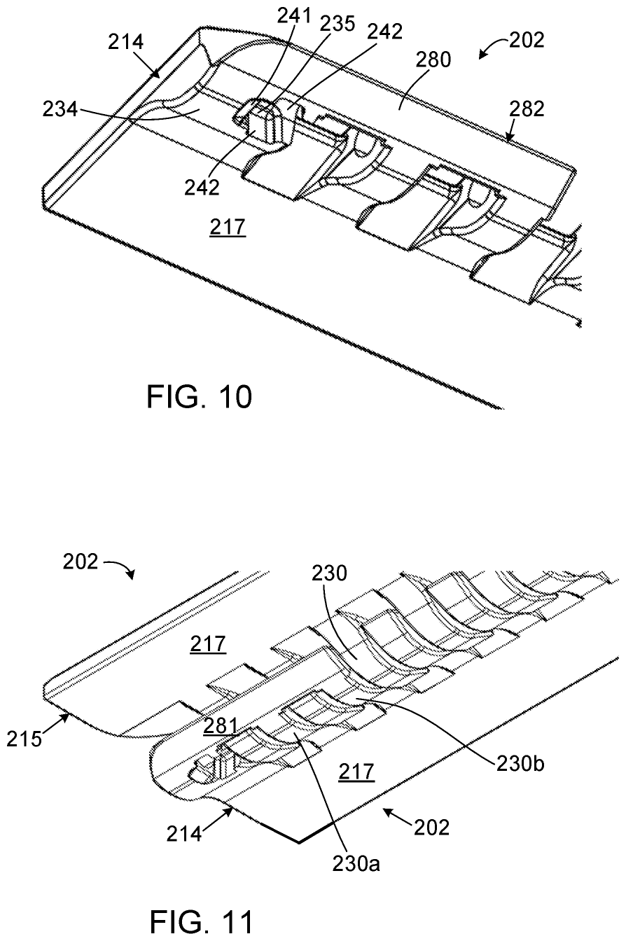

Referring to FIGS. 9 and 10, which show the bottom of a conveyor belt segment 202 near the first side 214, the slot 235 forming a portion of the hinge passageway near the side 214 includes a first angled surface 241 in the bottom surface 217 between the side edge 214 and slot 235 to facilitate rod insertion. The illustrative first angled surface 241 allows a hinge rod to snap into place after passing through the aligned hinge members 230 via the slot 235. The slot 235 further includes side recesses 242 to facilitate rod removal using a tool, such as needle-nose pliers. The pliers can grip the end of the hinge rod to pull it out through the slot 235.

In one embodiment, the solid edge portion 234 can bend or flex away from the hinge passageway to facilitate insertion and-or removal of a hinge rod. The bending or flexing increases access to the hinge passageway. After the rod is inserted or removed, the solid edge portion 234 automatically returns to the encapsulating position with the solid edge portion cradling the rod end.

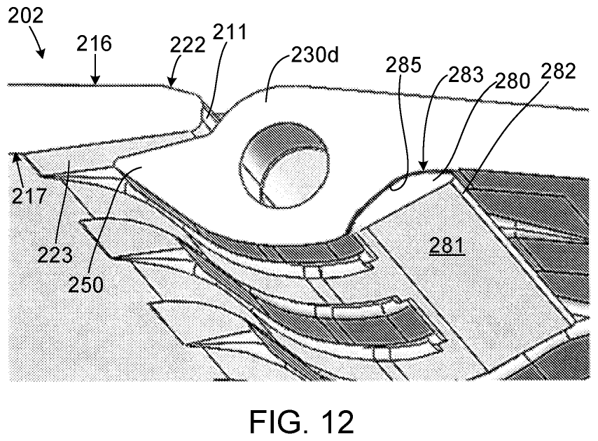

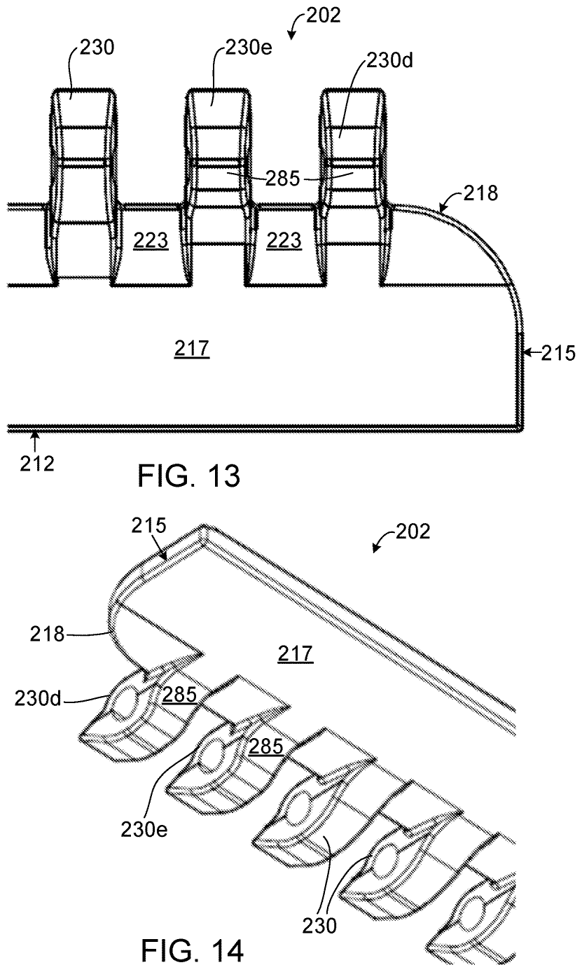

When assembled, as shown in FIGS. 11 and 12, the reinforcing link 280 abuts the back of the corresponding hinge elements 230 of the mating belt segment. As shown in FIGS. 12-14, the hinge elements 230d and 230e nearest the second side 215 of the belt segment 202 are shaped to include shaped recesses 285 to accommodate the shaped top surface 283 of the reinforcing link 280.

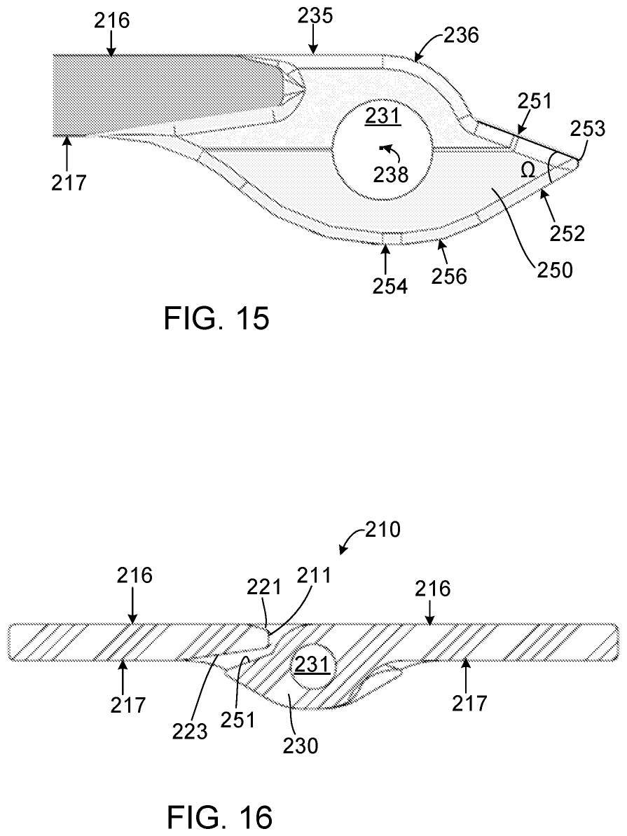

The hinge members 230 may be shaped to facilitate a connection between mating belt segments 202, 202. Referring to FIGS. 15 and 16, an illustrative hinge member 230 comprises a hinge body extending from an inner end of the belt segment 202. The hinge body may be substantially cylindrical and may include a lateral opening 231 formed in the body for receiving a hinge rod. The lateral opening 231 extends along an axis 238 that is preferably substantially parallel to the inner end of the belt segment 203 and below the inner surface 217 of the belt segment 203.

The illustrative hinge body has a top surface 235 that is continuous with the outer surface 216 of the belt segment. The top surface 235 transitions to a top convexly curved surface 236 having a center of curvature that coincides with the axis 238 of the hinge rod passageway formed by aligned openings 231.

The illustrative hinge member 230 includes a tapering nose 250 extending longitudinally from the hinge body for controlling the movement of the inner ends of the belt segment relative to each other when the fastening system 210 is assembled. The illustrative nose 250 comprises a protrusion extending from the hinge body 232 and tapering in height to a tip 253. The nose 250 includes angled interface surfaces 251, 252 that converge at the tip 253. The interface surfaces are angled to allow the fastening system to pre-deform around a drive sprocket or roller, reducing out-of-plane stresses that lead to degradation from fatigue over time and reduces the tendency of the fastening system edges to “lift” up causing catch point concerns. The tip 253 is below the inner surface 217 of the belt segment and the axis 238, with the top angled interface surface 251 starting above the axis 238 and terminating below the axis 238. The bottom angled interface surface 252 extends from the tip 253 towards the inner end of the belt segment and at an angle, such that the nose is substantially symmetric about the tip 253.

In an illustrative embodiment, the angled interface surfaces 251, 252 intersect at an angle Ω that is about 50°, but the invention is not so limited.

The hinge member 230 includes a bottom curved surface 256 extending from the bottom angled interface surface 252 away from the tip. The bottom curved surface 256 has a nadir 254 that is slightly longitudinally forward of the axis 238 and has a larger radius of curvature that the top convexly curved surface 236. The bottom curved surface 256 transitions to the bottom surface 217 of the belt segment 203 at a longitudinal location corresponding to the end of the bottom recess 223.

When the fastening system is fastened, as shown in FIG. 16, the hinge elements 250 interlace and the hinge rod is inserted in the hinge passageway formed by the hinge elements. In the fastened position, the angled interface surfaces 251 of the tapered noses 250 are spaced from and angled relative to the angled recesses 223 on the mating belt segment. The illustrative configuration facilitates bending of the conveyor belt around a sprocket or other guide device, while preventing tenting or overbending.

The illustrative fastening system provides a strong connection, facilitates assembly and disassembly while reducing rod migration due to the fully enclosed, heavy-duty edge design and reducing catchpoints that can lead to failure.

The scope of the claims is not meant to be limited to the details of the described exemplary embodiments.

What is claimed is:

1. A fastening system for fastening a first end of a conveyor belt segment to a second end of a conveyor belt segment, comprising:
at least one flexible belt segment, each flexible belt segment extending in a longitudinal direction from a first end to a second end, in a lateral direction from a first side edge to a second side edge and in thickness from an outer surface to an inner surface;
a plurality of laterally-spaced hinge members extending from the first end, the hinge members having aligned hinge openings forming a hinge passageway extending along a hinge axis; and
a reinforcing link extending between a tip of a first hinge member and a tip of a second hinge member adjacent the first hinge member.

2. The fastening system of claim 1, wherein the reinforcing link extends between the first hinge member, the second hinge member and a solid edge portion formed at the first side edge.

3. The fastening system of claim 2, wherein the reinforcing link includes a convexly curved top surface that slopes downwards from the tips of the first and second hinge members.

4. The fastening system of claim 3, wherein the inner surface of the flexible belt segment includes a shaped recess near the second side edge to accommodate a convexly curved top surface in a reinforcing link of a mating flexible belt segment.

5. The fastening system of claim 2, further comprising a viewing window adjacent the solid edge portion of the belt segment, the viewing window extending from the outer surface and intersecting the hinge passageway.

6. The fastening system of claim 5, further comprising a lateral slot in the inner surface aligned with the hinge openings and adjacent to the viewing window.

7. The fastening system of claim 6, further comprising an angled surface connecting an end of the lateral slot and the inner surface to facilitate insertion of a hinge rod.

8. The fastening system of claim 6, wherein the lateral slot includes side recesses to facilitate removal of a hinge rod.

9. The fastening system of claim 1, wherein each hinge member includes a tapering nose extending from a hinge body, the tapering nose having a top angled interface surface that angles downwards from above the hinge axis and terminating in a tip below the hinge axis.

10. The fastening system of claim 1, wherein the fastening system comprises two identical flexible belt segments that mate with each other.

11. The fastening system of claim 1, wherein the hinge elements comprise a rigid material overmolded with a flexible plastic material.

12. The fastening system of claim 1, further comprising a shaped shelf in the top surface between the reinforcing link and first side for receiving a shaped edge of a mating belt segment.

13. The fastening system of claim 12, wherein the shaped shelf includes a flat wall with a curved inner edge and a curved tapering wall intersecting the curved inner edge.

14. The fastening system of claim 12, further comprising a shaped edge between the second side edge and the first end that is configured to be seated in the shaped shelf of a mating flexible belt segment.

15. A fastening system for fastening a first end of a conveyor belt segment to a second end of a conveyor belt segment, comprising:
first and second belt segments, each belt segment extending in a longitudinal direction from a first end to a second end and having an outer surface and an inner surface,
a plurality of laterally-spaced hinge members extending from each first end, the hinge members having aligned hinge openings forming a hinge passageway, wherein the hinge passageway terminates in a solid edge at a first side of the belt segment to encapsulate a hinge rod inserted in the hinge passageway; and
a viewing window adjacent the solid edge extending from the outer surface to a lateral slot in the inner surface, wherein the lateral slot is aligned with the hinge openings.

16. The fastening system of claim 15, wherein the lateral slot includes a first angled surface in the bottom surface to facilitate rod insertion and side recesses to facilitate rod removal of a hinge rod using a tool.

17. The fastening system of claim 15, wherein the first and second belt segments are formed of a rigid plastic.

18. The fastening system of claim 15, further comprising:
a first reinforcing link extending between a tip of a first hinge member and a tip of a second hinge member adjacent the first hinge member in the first belt segment; and
a second reinforcing link extending between a tip of a third hinge member to a tip of a fourth hinge member adjacent the third hinge member on the second belt segment.

19. A fastening system for fastening a first end of a conveyor belt segment to a second end of a conveyor belt segment, comprising:
a hinge body extending longitudinally from a first end of a conveyor belt segment, the hinge body having a hinge opening extending along a hinge axis, wherein the conveyor belt segment has an outer surface and an inner surface; and
a tapering nose extending from the hinge body, the tapering nose having a top angled interface surface that angles downwards from above the hinge axis and terminating in a tip below the hinge axis.

20. The fastening system of claim 19, wherein the tapering nose further includes a bottom angled interface surface extending from the tip towards the first end of the conveyor belt segment, the bottom angled interface surface extending at an angle of about 50° relative to the top angled interface surface.

21. The fastening system of claim 20, wherein the hinge body includes an inner curved surface extending from the bottom angled interface surface.

22. The fastening system of claim 21, wherein the inner curved surface has a nadir that is longitudinally forward of the axis.

23. The fastening system of claim 21, wherein the inner curved surface has a radius of curvature that is larger than a top convexly curved surface of the hinge body.

24. The fastening system of claim 19, further comprising a solid edge portion at a first side edge of the conveyor belt segment, the solid edge portion including a lateral slot with a closed end aligned with the hinge body.

25. The fastening system of claim 24, further comprising a reinforcing link extending between the tapering nose and the solid edge portion.

26. The fastening system of claim 24, wherein the lateral slot is open to the inner surface of the conveyor belt segment.
